(19) United States
(12) Patent Application Publication
(10) Pub. No.: US 2013/0007968 A1
(43) Pub. Date: Jan. 10, 2013

(54) Cleaning Section For An Electric Oral Hygiene Device

(75) Inventors: Georges Driesen, Weilrod (DE); Alex Thalheim-Martin, Frankfurt am Main (DE); Bernd Trebitz, Butzbach (DE); Heidrun Schmelcher, Oberursel (DE); Eva Susanne Dominique Thurnay, Kronberg (DE); Michael Wolf, Wiesbaden (DE); Holger Port, Schwalbach (DE); Guenter Helbig, Schwalbach (DE)

(73) Assignee: Braun GmbH, Cincinnati, OH (US)

(21) Appl. No.: 13/541,802

(22) Filed: Jul. 5, 2012

Related U.S. Application Data
(60) Provisional application No. 61/504,805, filed on Jul. 6, 2011.

(51) Int. Cl. A61C 17/16

(52) U.S. Cl. 15/22.1

(57) ABSTRACT

A cleaning section for an electric oral hygiene device having a handle section includes a first end adapted to be connected to the handle section; a second end remote from the first end, the second end including a carrier mounted for rotation or oscillation around a rotation axis; and a plurality of cleaning elements mounted on the carrier, the cleaning elements being arranged in at least an inner band and an outer band. The inner band includes a plurality of first cleaning elements having a first color and a plurality of second cleaning elements having a second color. The outer band includes a plurality of third cleaning elements having a third color and a plurality of fourth cleaning elements having a fourth color. The cleaning elements of the inner band and the cleaning elements of the outer band have a Color Contrast (ΔE) of from about 85 to about 140.

### CROSS REFERENCE TO RELATED APPLICATION

This application claims the benefit of U.S. Provisional Application No. 61/504,805, filed on Jul. 6, 2011, which is incorporated herein by reference.

### FIELD OF THE INVENTION

The present disclosure relates generally to a cleaning section for an electric oral hygiene device, and more particularly to a cleaning section containing cleaning elements that exhibit an enhanced color contrast, resulting in facilitating consumers' identification and understanding of an improved cleaning efficacy.

### BACKGROUND OF THE INVENTION

Consumer behavior is a complex subject. Although it has been studied extensively within the realm of marketing science, much remains to be understood. The complexity and variety of things such as human perceptions, experiences, pre-existing knowledge, opinions and attitudes, cultural influences, social influences, demographics, emotions, motivations and reasoning processes in commercial settings often defy attempts to develop general rules or models that are consistently predictive of the perception, behavior or response of a consumer market segment in any particular set of circumstances.

For this reason, when producers of consumer products contemplate a new product launch, they often engage in extensive specific consumer research in an attempt to identify elements of an advertising theme, message, and specific embodiment and execution thereof that will be most effective in stimulating consumer interest, and most importantly, initial purchase intent by effectively communicating to particular consumers the benefits of a particular product and how a particular product meets an unmet need in consumer's life. Even when a product has demonstrable relevance, benefits and value for a segment of the consumer market, the nature and content of a message that will effectively motivate the consumer are rarely readily apparent or easily discovered. Similarly, conceptualization and design of materials that will effectively convey that message are not often easily accomplished.

Additionally, consumers may face an overwhelming number of product options when shopping for a specific oral hygiene product. Mass retailers usually shelve the same type of products, made by different manufactures, together on the shelf. In this regard, the goal of the retailer is to provide a large number of such products to be viewed quickly, permitting the consumer to compare the products for quality and value, and to easily find all offerings of specific product types in one place in the store. The length of time required, however, for consumers to select their desired product from this arrangement, is considerable and unworkable for many consumers.

Furthermore, it is believed that the longer it takes for a consumer to identify a desired product on the store shelf, the less likely they will select this product for purchase while in the store. This poses disadvantages for both the retailer and the manufacturer. This delay time in identifying the appropriate product on the store shelf can affect both initial purchase as well as the repurchase of that product. When it is difficult for the consumer to find the desired product in the retail store, the repurchase intent is also impacted, even if the consumer has used and liked the performance of a product in the past.

Accordingly, there is a need for a cleaning section for an oral hygiene device that rapidly and effectively communicates desired product benefits, so as to better stimulate interest and initial purchase intent.

### SUMMARY OF THE INVENTION

In one embodiment, a cleaning section for an electric oral hygiene device having a handle section is provided. The cleaning section includes a) a first end adapted to be connected to the handle section; b) a second end remote from the first end, the second end including a carrier mounted for rotation or oscillation around a rotation axis; and c) a plurality of cleaning elements mounted on the carrier, the cleaning elements being arranged in at least an inner band and an outer band. The inner band includes a plurality of first cleaning elements having a first color and a plurality of second cleaning elements having a second color. The outer band includes a plurality of third cleaning elements having a third color and a plurality of fourth cleaning elements having a fourth color. The cleaning elements of the inner band and the cleaning elements of the outer band have a Color Contrast (ΔE*) of from about 85 to about 140.

In another embodiment, a cleaning section for an electric oral hygiene device having a handle section is provided. The cleaning section includes a) a first end adapted to be connected to the handle section; b) a second end remote from the first end, the second end including a carrier mounted for rotation or oscillation around a rotation axis; and c) a plurality of cleaning elements mounted on the carrier, the cleaning elements being arranged in at least an inner band and an outer band. The inner band includes a plurality of first cleaning elements having a first color and a plurality of second cleaning elements having a second color. The outer band includes a plurality of third cleaning elements having a third color and a plurality of fourth cleaning elements having a fourth color. The cleaning elements within the outer band have a Color Contrast (ΔE*) of less than about 50% of the Color Contrast (ΔE*) of the cleaning elements of the inner band.

In another embodiment, a cleaning section for an electric oral hygiene device having a handle section is provided. The cleaning section includes a) a first end adapted to be connected to the handle section; b) a second end remote from the first end, the second end including a carrier mounted for rotation or oscillation around a rotation axis; and c) a plurality of cleaning elements mounted on the carrier, the cleaning elements being arranged in at least an inner band and an outer band. The inner band includes a plurality of cleaning elements having a first color and the outer band includes a plurality of cleaning elements having a second color and a plurality of cleaning elements having a third color. The cleaning elements of the inner band and the cleaning elements of the outer band have a Color Contrast (ΔE*) of from about 85 to about 140.

In another embodiment, a cleaning section for an electric oral hygiene device having a handle section is provided. The cleaning section includes a) a first end adapted to be connected to the handle section; b) a second end remote from the first end, the second end including a carrier mounted for rotation or oscillation around a rotation axis; and c) a plurality of cleaning elements mounted on the carrier, the cleaning elements being arranged in at least an inner band and an outer band. The inner band includes a plurality of first cleaning elements having a first color and a plurality of second cleaning elements having a second color, the cleaning elements within the inner band having a Color Contrast (ΔE*) of greater than about 95. The outer band includes a plurality of third cleaning elements having a third color and a plurality of fourth cleaning elements having a fourth color, the cleaning elements within the outer band having a Color Contrast (ΔE*) of less than about 60.

In another embodiment, a cleaning section for an electric oral hygiene device having a handle section is provided. The cleaning section includes a) a first end adapted to be connected to the handle section; b) a second end remote from the first end, the second end including a carrier mounted for rotation or oscillation around a rotation axis; and c) a plurality of cleaning elements mounted on the carrier, the cleaning elements being arranged in at least an inner band and an outer band. The inner band includes a plurality of cleaning elements having a cross-section in a substantially parallelogram shape. The outer band includes a plurality of cleaning elements having a cross-section in a substantially rectangular shape and a plurality of cleaning elements having a cross-section in a substantially trapezoidal shape, such that the cross-sections in the outer band alternate.

### BRIEF DESCRIPTION OF THE DRAWINGS

While the specification concludes with claims which particularly point out and distinctly claim the subject matter that is regarded as the invention, it is believed the various embodiments will be better understood from the following description taken in conjunction with the accompanying drawings, in which:

FIG. 1 is a perspective view of one embodiment of an electric oral hygiene device including a cleaning section according to one or more embodiments illustrated and described herein;

FIG. 2 is a perspective view of one embodiment of a cleaning section according to one or more embodiments illustrated and described herein;

FIG. 3 is a schematic depiction of a mounting surface of a carrier on which a schematic cleaning element is mounted and in which geometrical parameters are indicated;

FIG. 4A is a perspective depiction of an embodiment of a cleaning head of a cleaning section according to one or more embodiments illustrated and described herein;

FIG. 4B is a top view of the cleaning head shown in FIG. 4A;

FIG. 4C is a top view of a carrier used in the cleaning head shown in FIG. 4A without mounted cleaning elements;

FIG. 4D is a side view of the cleaning head shown in FIG. 4A;

FIG. 4E is a side view of another embodiment of the cleaning head shown in FIG. 4A;

FIG. 5A is a cross sectional cut through an exemplary tufting hole;

FIG. 5B is a cross sectional cut through another exemplary tufting hole;

FIG. 6 is a top view of one embodiment of a cleaning head having two coaxially arranged carriers;

FIG. 7A is a top view of a cleaning element holder according to one embodiment illustrated and described herein;

FIG. 7B is a perspective depiction of an apparatus used to make cleaning element films according to one embodiment illustrated and described herein;

FIG. 7C is a view of a cleaning element film according to one embodiment illustrated and described herein;

FIG. 7D is a perspective view of a base section of a film holder according to one embodiment illustrated and described herein;

FIG. 7E is a perspective view of a lid section of a film holder according to one embodiment illustrated and described herein; and

FIG. 7F is a perspective view of a film holder according to one embodiment illustrated and described herein.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

Although the embodiments are described herein in the context of an electric oral hygiene device, such as an electric toothbrush, embodiments are not limited thereto. Embodiments disclosed herein may be implemented in a wide-variety of applications, such as in the application of an electric tongue cleaner, and many others.

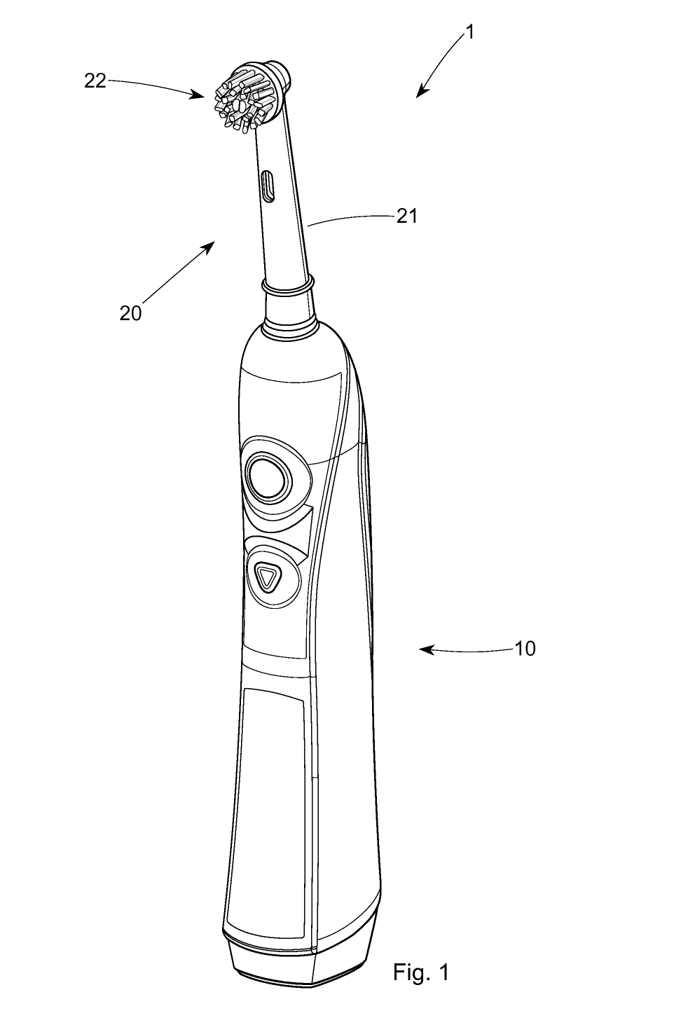

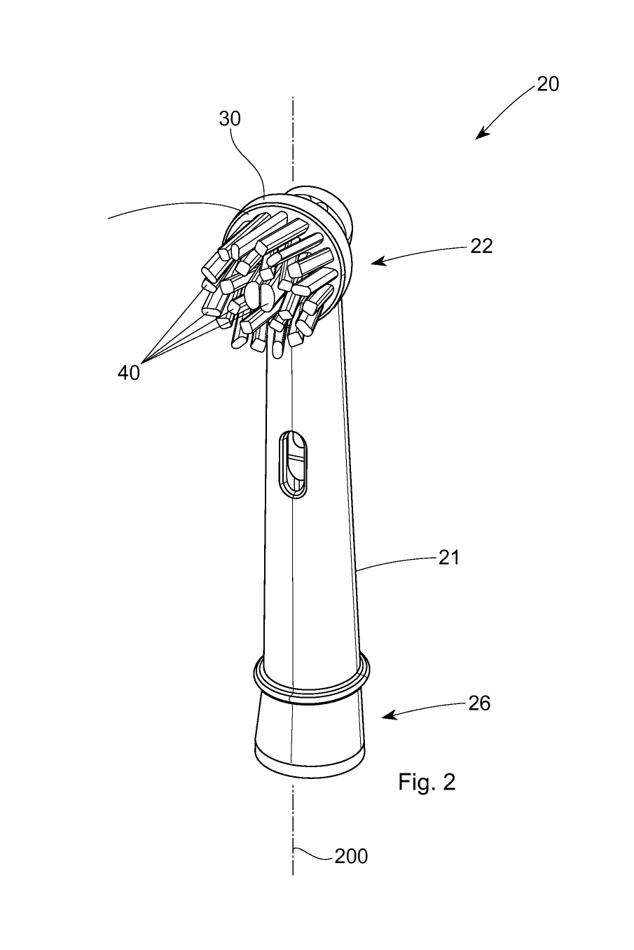

Referring now to FIG. 1, a general schematic of some of the components of one embodiment of an electric oral hygiene device is illustrated. In this embodiment, the oral hygiene device is shown as a power or electric toothbrush 1. The electric toothbrush 1 includes a cleaning section 20 and a handle section 10. The cleaning section 20 is more particularly shown in FIG. 2, and is discussed in more detail below. The handle section 10 includes an interior cavity (not shown) which typically contains an electric drive such as a motor, batteries, mechanical linkages for connecting the electric drive to further mechanical linkages in the cleaning section 20, electronic components for controlling the electrical operation of the toothbrush 1, and the like. In many different embodiments, one or more of those interior components may be omitted, or replaced with other components. For example, a corded electrical power supply can supplant the need for batteries. A switch may be used to turn the electric toothbrush 1 on and off, or otherwise to control operation of the electric toothbrush 1.

The electric drive in the handle section 10 imparts a motion to the mechanical linkages in the handle section 10. It may, for example, impart a rotary, oscillating, or rotary and oscillating motion to the mechanical linkages. The mechanical linkages in the handle section 10 are in turn coupled to additional mechanical linkages in the cleaning section 20, via a coupling member or the like. A suitable motor and mechanical linkage transmission system is disclosed for example in U.S. Patent Application Publication No. 2008/0307591 to Farrell et al., which is hereby incorporated by reference in its entirety. Movement of the combined mechanical linkages imparts a desired motion to a cleaning head portion 22 of the cleaning section 20 such that the cleaning head portion 22, or any component thereof, is caused to have a desired cleaning motion. Many different kinds of cleaning motions, including rotary, oscillating, vertical and/or horizontal sweeping and the like, may be used. Generally, as used herein, cleaning motion describes any desired or effective movement of the cleaning elements or bristles relative to other components in the toothbrush 1 to affect cleaning. Handle sections 10 and mechanical linkages are well known to the skilled artisan. The cleaning section 20 may be configured for use with such existing handle sections or may be configured with new handle section types, as the case may be.

The cleaning section 20, shown in more detail by FIG. 2, may be replaceable and capable of being push-fitted onto the handle section 10. The cleaning section 20 includes an elongated housing or neck portion 21 extending along a longitudinal axis 200 and a cleaning head portion for insertion into the oral cavity. The longitudinal axis 200 may coincide with a longitudinal section of a drive shaft member of the mechanical linkages. At a handle end 26, the elongated housing 21 may include a profile ring having an inside contour complementary with an outside contour of the handle section 10. In this manner, the cleaning section 20 can be push-fitted onto the handle section 10 in a manner preventing relative rotation of the cleaning section 20 with respect to the handle section 10. A tab/slot, key/spline or other similar structure may be included in the corresponding contour surfaces to facilitate alignment of the cleaning section 20 with the handle section 10 and to further prevent relative rotation between the two. The cleaning head portion 22 is mounted such that it can in operation be driven into a rotation or oscillating rotation around a rotation axis when the cleaning section 20 is attached to the handle section 10. Alternatively, the elongated housing 21 may be integrally formed with the handle section 10.

The illustrated cleaning head portion 22 has a substantially circular shape, although it may alternatively have a generally elliptical, rectangular, oblong, oval or other suitable shape. In some embodiments, the cleaning head portion 22 includes a carrier 30 which supports a plurality of cleaning elements 40 that are mounted to the carrier 30. The cleaning head portion 22 is mounted such that it can in operation be driven into a rotation or oscillating rotation around a rotation axis when the cleaning section 20 is attached to a handle section 10. Any suitable method of mounting the cleaning elements 40 to the carrier 30 may be used. For example, where the cleaning elements 40 comprise a plurality of bristles, methods such as hot tufting, gluing, stapling, and the like, may be utilized. As another example, where the cleaning elements 40 comprise a plurality of elastomeric elements, methods such as gluing, snap-fitting, welding, molding, etc. may be utilized.

The term “cleaning elements” is used to refer to any suitable element which can be inserted into the oral cavity. Some suitable elements include bristle tufts, elastomeric massage elements, elastomeric cleaning elements, massage elements, tongue cleaners, soft tissue cleaners, hard surface cleaners, combinations thereof, and the like. The cleaning elements 40 may include a wide variety of materials and may have a number of different configurations. Any suitable material and/or any suitable configuration may be utilized. For example, in some embodiments, the cleaning elements 40 may comprise tufts. The tufts may comprise a plurality of individual filaments which are securely attached to a cleaning element carrier. Such filaments may be polymeric and may include polyamide or polyester or a thermoplastic elastomeric polyamide grind or mixtures thereof. The longitudinal and cross sectional dimensions of the filaments and the profile of the filament ends can vary. Additionally, the stiffness, resiliency and shape of the filament end can vary. Some examples of suitable dimensions include a length between about 6.0 mm and about 10 mm and in another embodiment between about 7.0 mm and about 8.5 mm, or any individual number within these ranges. Additionally, the filaments may include a substantially uniform cross-sectional dimension of between about 100 to about 350 microns, in another embodiment in a range of between about 125 microns and about 175 microns, or any individual number within these ranges. The tips of the filaments may be any suitable shape, examples of which include a smooth tip, a rounded tip, tapered and a pointed tip. In some embodiments, the filaments may include a dye which indicates wear of the filaments as described in U.S. Pat. No. 4,802,255. Other suitable examples of filaments are described in U.S. Pat. No. 6,018,840. In some embodiments, the cleaning element fields may comprise fins as described in U.S. Pat. No. 6,553,604, and U.S. Patent Application Publication Nos. 2004/0177462; 2005/0235439; and 2005/0060822. In some embodiments, the cleaning element fields may comprise a combination of fins and tufts.

In one embodiment, the head may comprise a variety of cleaning elements. For example, the cleaning head portion 22 may comprise bristles, abrasive elastomeric elements, elastomeric elements in a particular orientation or arrangement, for example, pivoting fins, prophy cups, or the like. Some suitable examples of elastomeric cleaning elements and/or massaging elements are described in U.S. Patent Application Publication Nos. 2007/0251040; 2004/0154112; 2006/0272112; and in U.S. Pat. Nos. 6,553,604; 6,151,745. The cleaning elements may be tapered, notched, crimped, dimpled, or the like. Some suitable examples of these cleaning elements and/or massaging elements are described in U.S. Pat. Nos. 6,151,745; 6,058,541; 5,268,005; 5,313,909; 4,802,255; 6,018,840; 5,836,769; 5,722,106; 6,475,553; and U.S. Patent Application Publication No. 2006/0080794.

The cleaning head portion 22 may comprise a soft tissue cleanser constructed of any suitable material. The soft tissue cleanser may comprise any suitable soft tissue cleansing elements. Some examples of such elements as well as configurations of soft tissues cleansers on a toothbrush are described in U.S. Patent Application Nos. 2006/0010628; 2005/0166344; 2005/0210612; 2006/0195995; 2008/0189888; 2006/0052806; 2004/0255416; 2005/0000049; 2005/0038461; 2004/0134007; 2006/0026784; 20070049956; 2008/0244849; 2005/0000043; 2007/140959; and U.S. Pat. Nos. 5,980,542; 6,402,768; and 6,102,923.

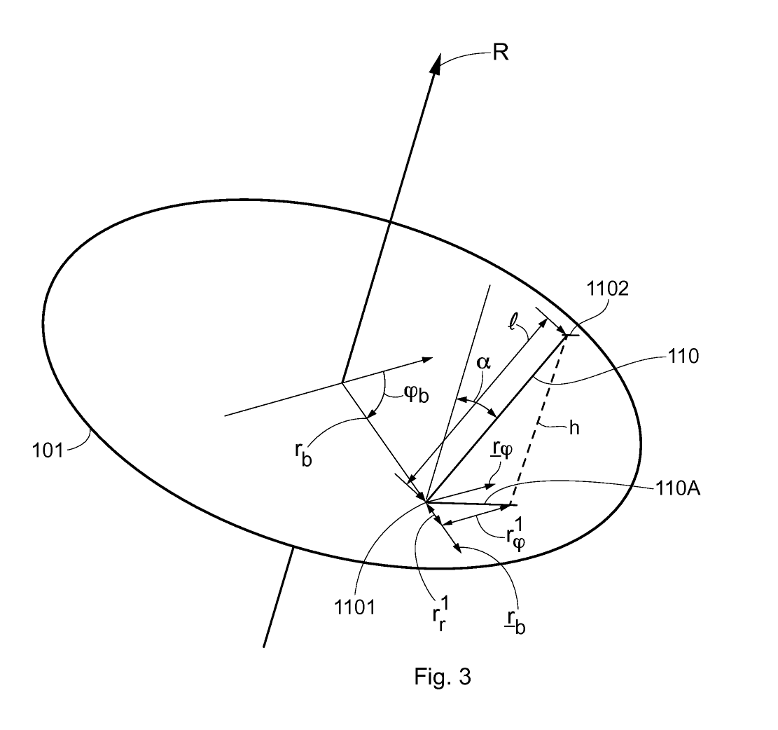

FIG. 3 is a schematic depiction of an example cleaning element 110 mounted on a schematically shown flat mounting surface 101 of a carrier. It shall be assumed that the carrier is mounted for rotation (or oscillating rotation) around a rotation axis R that is perpendicular to the flat mounting surface 101. The base 1101 of the cleaning element 110 has a location on the mounting surface that can be defined with respect to the location where the rotation axis R crosses the mounting surface 101 by means of polar coordinates r and φ (radial distance and relative angular position). The base 1101 of the cleaning element 110 has a location on the mounting surface that is given by r_{b} and φ_{b}. The cleaning element 110 has a free end 1102 and a length l. The parallel projection 110A along the direction of the rotation axis R of the cleaning element 110 onto the mounting surface 101 can be divided into a portion rᵣ^{⊥} that extends along the radial beam r_{b} originating at the rotation axis and going through the base 1101 of the cleaning element 110 and into a portion r_{φ}^{⊥} that extends into a circumferential direction r_{φ} that lies in the plane defined by the mounting surface 101 and that is perpendicular to the radial beam r_{b} and that crosses the base 1101 of the cleaning element 110. A cleaning element being inclined such that it has a final radial portion rᵣ^{⊥} of its parallel projection but where the circumferential portion r_{φ}^{⊥} is zero, r_{φ}^{⊥}=0, is not inclined in circumferential direction but is only inclined in radial direction. A cleaning element where also the radial portion rᵣ^{⊥} is zero, rᵣ^{⊥}=0, is not inclined with respect to the rotation axis but extends parallel to the rotation axis. Circumferential inclination can occur either in clockwise direction or in counter-clockwise direction. In case that the parallel projection 110A of the cleaning element 110 has no radial portion (rᵣ^{⊥}=0) but a circumferential portion (r_{φ}^{⊥}≠0), then the cleaning element 110 is only circumferentially inclined within the meaning of the present disclosure. In such a case, the parallel projection 110A extends along a tangent at a circle around the rotation axis having a radius r_{b}, where the base of the cleaning element forms the touch point at the circle. In the shown example, the free end 1102 of the cleaning element 110 lies radially farther outward than the base 1101. This situation would still exist in cases where the cleaning element 101 has zero radial inclination in accordance with the here given definition of radial inclination. The inclination angle α of the cleaning element 110 relative to the rotation axis R is defined as the angle between a line parallel to the rotation axis that goes through the base 1101 of the cleaning element 110 and the cleaning element 110. In case that the inclination angle α is zero, α=0, the height h of the cleaning element measured in the direction of the rotation axis is identical to the length l of the cleaning element 110. In case the cleaning element 110 is inclined by an angle α relative to the rotation axis, then the height h is less than the length l, h=1·cos(α)<1.

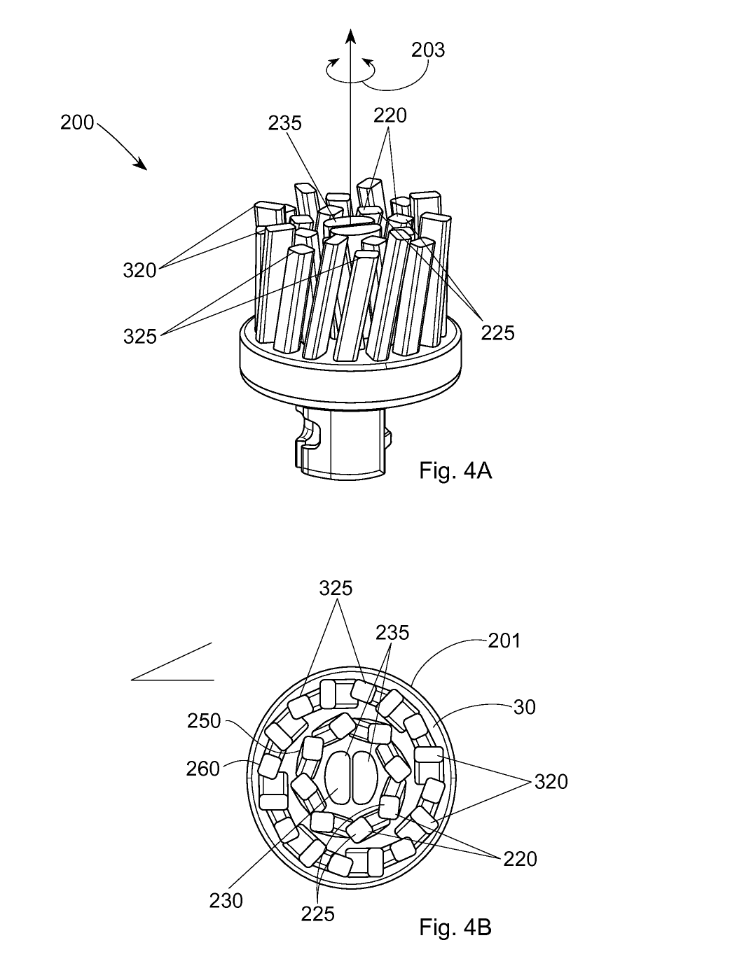

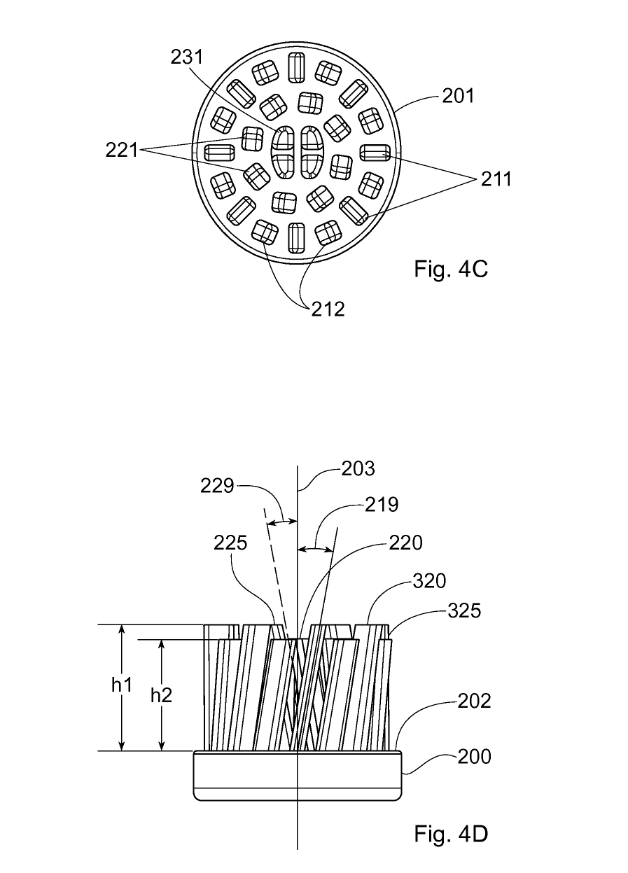

As seen in the perspective view of FIG. 4A and FIG. 4B, cleaning head 200 may include a plurality of cleaning elements and an axis of rotation 203. The plurality of cleaning elements are arranged on the upper side of the cleaning head 200 on an inner band 250, an outer band 260 and in an inner zone 230. The inner band 250 is adjacent to and closer to the center of the carrier 30 than outer band 260. In one embodiment, inner band 250 and outer band 260 are arranged in a ring-like configuration. In another embodiment, inner band 250 and outer band 260 may also be configured in a generally elliptical, rectangular, oblong, oval, polygonal or any other suitable configuration.

In one embodiment, inner band 250 includes a plurality of first cleaning elements 220 and a plurality of second cleaning elements 225. In one embodiment, the first cleaning elements 220 and the second cleaning elements 225 are arranged in an alternating manner on the inner band 250 so that the cleaning elements form a pattern, for example, first cleaning element 220, adjacent to second cleaning element 225, adjacent to first cleaning element 220, around the periphery of the inner band 250. In one embodiment, as shown in FIG. 4A and FIG. 4B, inner band 250 includes four first cleaning elements 220 and four second cleaning elements 225. In another embodiment, inner band 250 may include various other numerical combinations of first and second cleaning elements 220 and 225, respectively. In one embodiment, there exists a gap or space of from about 0.5 mm to about 1.5 mm between the base of the first cleaning elements and the base of the second cleaning elements

In one embodiment, as shown in FIG. 4A and FIG. 4B, first cleaning elements 220 and second cleaning elements 225 have the same length and cross-section (where the cross-section is taken in a plane perpendicular to the rotation axis 203). In another embodiment, first cleaning elements 220 may differ from second cleaning elements 225 in one or more cleaning element properties, for example, length, cross-sectional area, cross-sectional structure, radial inclination angle, surface structuring, material, and composition. In one embodiment, as shown in FIG. 4A and FIG. 4B, first and second cleaning elements 220, 225 are circumferentially inclined in a clockwise direction. In another embodiment, first and second cleaning elements 220, 225 may be circumferentially inclined in a counter-clockwise direction. As such, a free end of the cleaning element is farther away in the circumferential direction than a base of the respective cleaning element.

In one embodiment, as shown in FIG. 4A and FIG. 4B, first and second cleaning elements 220, 225 have a circumferential inclination angle of about 16 degrees. In another embodiment, the inclination angle of the first and second cleaning elements 220, 225 is about 10 degrees. In another embodiment, the inclination angle of the first and second cleaning elements 220, 225 is in the range of from about 0 degrees to about 35 degrees; in another embodiment, from about 5 degrees to about 25 degrees; and in yet another embodiment, from about 8 degrees to about 20 degrees. In a further embodiment, the inclination angle of the first cleaning elements 220 may alternate between two different values around the inner band 250, for example, one first cleaning element 220 may have an inclination angle of about 10 degrees, while a different first cleaning element 220 may have an inclination angle of about 13 degrees. The inclination angles of the second cleaning elements 225 may also alternate between two different values in the same manner as just described. In a further embodiment, the first cleaning elements 220 may be inclined while the second cleaning elements 225 have no inclination angle. Additionally, the second cleaning elements 225 may have an inclination angle that is equal to or less than the inclination angle of the first cleaning elements 220.

In one embodiment, outer band 260 includes a plurality of third cleaning elements 320 and a plurality of fourth cleaning elements 325. In one embodiment, the third cleaning elements 320 and the fourth cleaning elements 325 are alternatingly arranged on the outer band 260 so that the cleaning elements form a pattern, for example, third cleaning element 320, adjacent to fourth cleaning element 325, adjacent to third cleaning element 320, around the outer band 260. In one embodiment, as shown in FIG. 4A and FIG. 4B, outer band 260 includes eight third cleaning elements 320 and eight fourth cleaning elements 325. In one embodiment, there exists a gap or space of from about 0.5 mm to about 1.5 mm between the base of the third cleaning elements and the base of the fourth cleaning elements.

In another embodiment, outer band 260 may include various other numerical combinations of third and fourth cleaning elements 320 and 325, respectively. In one embodiment, as shown in FIG. 4A and FIG. 4B, third cleaning elements 320 and fourth cleaning elements 325 have different lengths and cross-sections. In another embodiment, third cleaning elements 320 and fourth cleaning elements 325 may have the same length and/or cross-section. In another embodiment, third cleaning elements 320 may also differ from fourth cleaning elements 325 in one or more cleaning element properties, for example, radial inclination angle, surface structuring, material, and composition. In one embodiment, as shown in FIG. 4A and FIG. 4B, third and fourth cleaning elements 320, 325 are circumferentially inclined in a counter-clockwise direction. In another embodiment, third and fourth cleaning elements 320, 325 may be circumferentially inclined in a clockwise direction.

In one embodiment, as shown in FIG. 4A and FIG. 4B, third and fourth cleaning elements 320, 325 have an inclination angle of about 16 degrees. In another embodiment, the inclination angle of the third and fourth cleaning elements 320, 325 is about 10 degrees. In another embodiment, the inclination angle of the third and fourth cleaning elements 320, 325 is in the range of from about 0 degrees to about 35 degrees; in another embodiment, from about 5 degrees to about 25 degrees; and in yet another embodiment, from about 8 degrees to about 20 degrees. In a further embodiment, the inclination angle of the third cleaning elements 320 may alternate between two different values around the outer band 260, for example, one third cleaning element 320 may have an inclination angle of about 10 degrees, while a different third cleaning element 320 may have an inclination angle of about 13 degrees. The inclination angles of the fourth cleaning elements 325 may also alternate between two different values in the same manner as just described. In a further embodiment, the third cleaning elements 320 may be inclined while the fourth cleaning elements 325 have no inclination angle. Additionally, the fourth cleaning elements 325 may have an inclination angle that is equal to or less than the inclination angle of the third cleaning elements 320.

In one embodiment, as shown in FIG. 4A and FIG. 4B, third cleaning elements 320 have a larger length (and thus also a larger height) than the fourth cleaning elements 325. In this embodiment, third cleaning elements 320 also have an elongated, roughly rectangular cross-section, where the longer axis of the elongated cross-section is essentially radially oriented, while the fourth cleaning elements 325 have a more compact, roughly square cross-section, where a slightly longer axis may be essentially circumferentially oriented. In one embodiment, the inner zone 230 includes two cleaning elements 235 that are substantially straight (i.e. extend parallel to the rotation axis 230) and are elongated and roughly kidney-shaped. However, any suitable length, shape or number of cleaning elements may also be used for the inner cleaning elements 235.

In one embodiment, as shown in FIGS. 4A and 4B, inner band 250 includes a plurality of first cleaning elements 220 having a first color, for example, yellow or blue, and a plurality of second cleaning elements 225 having a second color, for example, orange or green. In one embodiment, the first color and the second color may alternate around the inner band 250, such that, moving in a clockwise direction around the inner band 250, a first cleaning element 220 can be yellow, the adjacent second cleaning element 225 can be orange, the adjacent first cleaning element 220 can be yellow, and the adjacent second cleaning element 225 can be orange, etc. around the inner band 250. In another embodiment, the first color and the second color may alternate around the inner band 250, such that, moving in a clockwise direction around the inner band 250, a first cleaning element 220 can be blue, the adjacent second cleaning element 225 can be green, the adjacent first cleaning element 220 can be blue, and the adjacent second cleaning element 225 can be green, etc. around the inner band 250. In another embodiment, the plurality of cleaning elements included in the inner band 250 may all have the same color, for example, orange.

In another embodiment, bundling of the first and second cleaning elements by color may occur. For example, a first cleaning element 220 having a height (h₁) that is yellow can be paired with a second cleaning element 225 having a height (h₂) that is also yellow and adjacent thereto could be a first cleaning element 220 having a height (h₁) that is orange can be paired with a second cleaning element 225 having a height (h₂) that is also orange. This type of pattern can be repeated around the periphery of the inner band 250 or the outer band 260.

In one embodiment, as shown in FIGS. 4A and 4B, outer band 260 includes a plurality of third cleaning elements 320 having a third color, for example, light blue, and a plurality of fourth cleaning elements 325 having a fourth color, for example, white or blue. In one embodiment, the third color and the fourth color may alternate around the outer band 260, such that, moving in a counter-clockwise direction around the outer band 260, a third cleaning element 320 can be light blue, the adjacent fourth cleaning element 325 can be blue, the adjacent third cleaning element 320 can be light blue, and the adjacent fourth cleaning element 325 can be blue, etc. around the outer band 260. In another embodiment, the third color and the fourth color may alternate around the outer band 260, such that, moving in a counter-clockwise direction around the outer band 260, a third cleaning element 320 can be light blue, the adjacent fourth cleaning element 325 can be white, the adjacent third cleaning element 320 can be light blue, and the adjacent fourth cleaning element 325 can be white, etc. around the outer band 260.

In one embodiment, the plurality of cleaning elements 40 can be mounted to the carrier 30 in the form of tufts in such a way that each tuft may include clusters of individual elements or filaments having different colors. For example, a tuft located on the inner band 250 may include a cluster of individual elements or filaments having a first color, for example, yellow, and a cluster of individual elements or filaments having a second color, for example, orange, both clusters of elements or filaments arranged in the same tuft. Similarly, in another embodiment, a tuft located on the outer band 260 may include a cluster of individual elements or filaments having a third color, for example, light blue, and a cluster of individual elements or filaments having a fourth color, for example, white, both clusters of elements or filaments arranged in the same tuft.

In the embodiments discussed above, the first, second, third and fourth colors are different. Cleaning element colors can be precisely defined by color spectroscopy using the L*a*b* color space (also referred to as CIELAB). CIELAB describes all the colors visible to the human eye. The three coordinates of CIELAB represent the lightness of the color (L*=0 yields black and L*=100 indicates diffuse white; its position between red/magenta and green (a*, negative values indicate green while positive values indicate magenta) and its position between yellow and blue (b*, negative values indicate blue and positive values indicate yellow). L*a*b* values for various cleaning elements are illustrated in Table I below. The L*a*b* values illustrated in Table I were obtained using the PANTONE PLUS SERIES SOLID CHIPS PANTONE MATCHING SYSTEM (PMS) developed by Pantone LLC of Carlstadt, N.J. together with Adobe Photoshop® CS2 software. Filament colors were selected and matched qualitatively to Pantone reference cards under controlled light conditions corresponding to CIE Standard Illuminant D65. As is seen in Table I, each color may have more than one corresponding Pantone reference number for purposes of the present disclosure.

TABLE I

| | | | | Correlation |
|---|---|---|---|---|
| Cleaning Element Color | | | | between |
| (PMS reference #) | L* | a* | b* | a* and b* |
| Light blue | min—49 | min—(−30) | min—(−46) | a* negative |
| (277, 279, 283, 284, 292, | max—80 | max—(−5) | max—(−14) | b* negative |
| 2915, 2925, 297, 298, 299, 2995) | avg—67.5 | avg—(−16.4) | avg—(−35) | \|b*\| ≧ \|a*\| |
| Orange | min—64 | min—26 | min—57 | a* positive |
| (137, 1375, 151, 1495, 1505, | max—88 | max—60 | max—88 | b* positive |
| 1575, 1585, 164, 165, 804) | avg—71.1 | avg—48.1 | avg—71.5 | b* ≧ a* |
| Dark blue | min—15 | min—(−4) | min—(−78) | a* slightly |
| (2736, 2746, 2756, 2766, | max—46 | max—38 | max—(−30) | neg. to medium |
| 072, 2747, 2738, 2748, 280, | avg—21.9 | avg—19 | avg—(−59.5) | positive |
| 286, 287, 293, 285) | | | | b* (strongly) |
| | | | | negative |
| | | | | \|b*\| ≧ \|a*\| |
| Yellow | min—72 | min—(−7) | min—60 | a* almost zero |
| (012, 102, 107, 108, 109, | max—91 | max—9 | max—114 | b* strongly |
| 113, 114, 115, 116) | avg—88.5 | avg—0.1 | avg—92.5 | positive |
| Green | min—60 | min—(−76) | min—37 | a* negative |
| (354, 360, 361, 368, 369, | max—70 | max—(−36) | max—72 | b* positive |
| 376) | avg—65.2 | avg—(−50.5) | avg—54 | |
| Medium Blue | min—27 | min—(−7) | min—(−68) | a* almost zero |
| (2727, 2728, 279, 285, 293, | max—58 | max—16 | max—(−42) | b* negative |
| 2935) | avg—42.7 | avg—2.2 | avg—(−58.8) | \|b*\| ≧ \|a*\| |
| White | min—88 | min—(−5) | min—(−5) | |
| | max—100 | max—5 | max—5 | |
| | avg—94 | avg—0 | avg—0 | |

Once the appropriate L*a*b* ranges for cleaning elements for use in accordance with the present disclosure were determined using the PANTONE MATCHING SYSTEM, the L*a*b* values for specific cleaning elements can be measured using a spectrometer. The L*a*b* values illustrated in Tables II and III were obtained using a Konica Minolta CM-2600d Spectrophotometer* available from Konica Minolta Sensing Americas, Inc, New Jersey. The method for measuring the L*a*b* values will be described in the “Test Methods” section.

TABLE II

| Cleaning Element Color | L* | a* | b* |
|---|---|---|---|
| (n = 6) | (avg) | (avg) | (avg) |
| Green | 61.8 ± 1.21 | (−40.8) ± 0.86 | 42.9 ± 0.85 |

*SCE mode for SAV using Minolta CM-2600d

TABLE III

| Cleaning Element | L* | a* | b* |
|---|---|---|---|
| Color | (avg) | (avg) | (avg) |
| Light Blue | | | |
| Sample #1 (n = 3) | 51.12 ± 0.36 | (−12.59) ± 0.16 | (−16.61) ± 0.27 |
| Sample #2 (n = 3) | 50.52 ± 0.27 | (−12.38) ± 0.06 | (−15.86) ± 0.08 |
| Sample #3 (n = 3) | 52.19 ± 0.10 | (−12.15) ± 0.05 | (−15.64) ± 0.08 |
| | 51.28 ± 0.84 | (−12.37) ± 0.22 | (−16.03) ± 0.51 |
| Orange | | | |
| Sample #1 (n = 3) | 73.41 ± 0.05 | 26.02 ± 0.06 | 61.49 ± 0.08 |
| Sample #2 (n = 3) | 78.87 ± 0.09 | 29.18 ± 0.08 | 66.74 ± 0.04 |
| Sample #3 (n = 3) | 77.68 ± 0.10 | 29.36 ± 0.18 | 65.89 ± 0.33 |
| | 76.65 ± 2.87 | 28.19 ± 1.88 | 64.71 ± 2.82 |
| Dark Blue | | | |
| Sample #1 (n = 3) | 24.93 ± 0.02 | 7.69 ± 0.12 | (−33.39) ± 0.20 |
| Sample #2 (n = 3) | 25.28 ± 0.07 | 7.75 ± 0.19 | (−34.29) ± 0.24 |
| Sample #3 (n = 3) | 26.13 ± 0.12 | 6.37 ± 0.04 | (−31.77) ± 0.06 |
| | 25.45 ± 0.62 | 7.27 ± 0.78 | (−33.15) ± 1.28 |
| Yellow | | | |
| Sample #1 (n = 3) | 75.77 ± 0.04 | (−2.38) ± 0.06 | 63.99 ± 0.05 |
| Sample #2 (n = 3) | 74.20 ± 0.23 | (−2.48) ± 0.05 | 61.06 ± 0.17 |
| Sample #3 (n = 3) | 75.82 ± 0.10 | (−2.43) ± 0.02 | 62.33 ± 0.05 |
| | 75.26 ± 0.92 | (−2.43) ± 0.05 | 62.46 ± 1.47 |
| Green | | | |
| Sample #1 (n = 3) | 66.17 ± 0.03 | (−39.56) ± 0.01 | 44.25 ± 0.02 |
| Sample #2 (n = 3) | 65.88 ± 0.07 | (−39.12) ± 0.08 | 43.97 ± 0.02 |
| Sample #3 (n = 3) | 64.38 ± 0.05 | (−38.84) ± 0.04 | 43.52 ± 0.10 |
| | 65.48 ± 0.05 | (−39.17) ± 0.37 | 43.92 ± 0.37 |
| White | | | |
| Sample #1 (n = 3) | 90.73 ± 0.08 | 1.23 ± 0.02 | (−4.42) ± 0.02 |
| Sample #2 (n = 3) | 90.78 ± 0.06 | 1.30 ± 0.01 | (−4.66) ± 0.01 |
| Sample #3 (n = 3) | 89.79 ± 0.05 | 1.15 ± 0.03 | (−3.86) ± 0.03 |
| | 90.43 ± 0.56 | 1.22 ± 0.08 | (−4.32) ± 0.41 |

*SCE mode for SAV using Minolta CM-2600d

Using L*a*b* values for the plurality of cleaning elements, a color difference or color contrast (ΔE*) between the first and second cleaning elements 220, 225 in the inner band 250 can be defined. In another embodiment, the ΔE* between the first and second cleaning elements, 320, 325 in the outer band 260 can be defined. In another embodiment, the ΔE* between the cleaning elements of the inner band 250 and the cleaning elements of the outer band 260 can be defined.

The ΔE* measurement or color contrast between cleaning elements can be determined by the following equation: ΔE* is the vector length difference between E₁*(L₁*, a₁*, b₁*) and E₂*(L₂*, a₂*, b₂*)

ΔL*=L₁*−L₂*

Δa*=a₁*−a₂*

Δb*=b₁*b₂*

ΔE*=(ΔL*²+Δa*²+Δb*²)^{1/2}

As an example, using the average L*a*b* values for light blue (L₁*a₁*b₁*) and white (L₂*a₂*b₂*) from Table I above, the ΔE* is determined as follows:

ΔE*=(702+269+1225)^{1/2}=46.9

As another example, using the average L*a*b* values from Table III above, the ΔE* is determined for one of the embodiments according to the present disclosure having first and second cleaning elements 220, 225 in the inner band 250 (green and dark blue) and having first and second cleaning elements, 320, 325 in the outer band 260 (light blue and white) can be defined.

TABLE IV

| Cleaning Element Color | Color Contrast (ΔE*) |
|---|---|
| Light Blue | 43.0 |
| White | |
| White | 67.6 |
| Green | |
| White | 71.3 |
| Dark Blue | |
| Light Blue | 67.1 |
| Green | |
| Light Blue | 36.7 |
| Dark Blue | |
| Green | 98.5 |
| Dark Blue | |

In order to provide a cleaning head 200 that provides visual stimulation and visual characteristics to a consumer that reflects certain performance characteristics and product benefits/features, for example, improved cleaning efficacy, the cleaning elements of the inner band 250 and the cleaning elements of the outer band 260 need to have an appropriate range of color contrast. In one embodiment, the ΔE* between the cleaning elements of the inner band 250 and the cleaning elements of the outer band 260 is from about 85 to about 140; in another embodiment from about 100 to about 130; in another embodiment from about 110 to about 120; in another embodiment of greater than about 85; and in another embodiment of greater than about 100. In order to obtain a high color contrast between cleaning elements of the inner and outer bands, the color contrast for the cleaning elements within each individual band must be relatively low. For example, in one embodiment, the ΔE* for the cleaning elements within the inner band 250 is less than about 60; in another embodiment less than about 50 and in another embodiment less than 40. Similarly, in another embodiment, the ΔE* for the cleaning elements within outer band 260 is less than about 60; in another embodiment less than about 50 and in another embodiment less than 40. As a result, consumers can more easily perceive the different band on the cleaning head 200 thus facilitating consumers' identification and understanding of improved cleaning properties. In this way, desired product selection by the consumer is enhanced. Consumers are better able to obtain the product that they prefer or desire, and may be able to make desired product selections more efficiently.

According to another embodiment, enhanced visual perception of the arrangement of the cleaning elements on cleaning head 200 and thus the product benefits that may result from such an arrangement, can be accomplished by the cleaning elements of the inner band 250 having high color contrast and the cleaning elements of the outer band 260 having a low color contrast. For example, in one embodiment, the ΔE* for the cleaning elements of the inner band 250 is greater than about 95 and in another embodiment greater than about 105, while the ΔE* for the cleaning elements of the outer band is less than about 60 and in another embodiment, less than about 50.

The embodiment shown in FIG. 4C shows a top view onto the first carrier 201 without mounted cleaning elements so that the mounting holes 211, 212, 221, 231 of the plurality of cleaning elements are visible. The geometry of the mounting holes essentially defines the cross-sectional shape, the cross-sectional area and orientation of cleaning elements 40. In one embodiment, the outer band 260 includes mounting holes 211 and 212 that are alternately arranged. The mounting holes 211 of the plurality of third cleaning elements 320 are elongated and substantially rectangular. The mounting holes 212 of the plurality of fourth cleaning elements 325 are substantially trapezoidal. However, any suitable shape for mounting holes 211 and 21 can be used. As further shown in the embodiment of FIG. 4c, the inner band 250 includes mounting holes 221 of the plurality of first and second cleaning elements 220, 225. Mounting holes 221 are substantially parallelogram-like. However, any suitable shape for mounting holes 221 can be used. The mounting holes 231 of the inner zone 230 are formed as roughly kidney-shaped holes that are each realized as a double-hole with a separation wall between the sub-holes. Each sub-hole is arranged to accommodate a single cleaning element, but because of the proximity of the two sub-holes, the two cleaning elements will give the impression of a single, roughly kidney-shaped tuft.

FIG. 4D is a side view onto the cleaning head 200 of one exemplary embodiment. It can be seen that the plurality of cleaning elements 320 and 325 in the outer band are inclined against the rotation axis 203 with a first inclination angle 219 in a first circumferential direction and the plurality of cleaning elements 220 and 225 in the inner band are inclined against the rotation axis 203 with a second inclination angle 229 in a second circumferential direction opposite to the first circumferential direction. It can also be understood from this view that the outer band cleaning elements and the inner band cleaning elements are arranged such that each outer band cleaning element is by at least one or more inner band cleaning elements when viewed from the side. In other words, “crossed” means that a radial beam originating at the rotation axis 203 and being parallel to the mounting surface 202 that moves along the longitudinal axis of an inner band cleaning element crosses the longitudinal center line of at least one outer band cleaning element. It can be further seen that the outer band cleaning elements 320, 325 have alternating length and thus have alternating heights h1 and h2. Third cleaning elements 320 have a height h1 and are cut flat at their free end, the flat cut being parallel to the mounting surface 202. Fourth cleaning elements 325 have a height h2 and are cut flat at their free end, the flat cut being parallel to the mounting surface 202. In one embodiment, the absolute height difference |h1−h2| of the cleaning elements of the may be chosen to lie in a range of between about 0.5 mm and about 2.0 mm, in another embodiment between about 0.7 mm and about 1.5 mm. These height differences are adequate for the curvature of regular teeth such as molars and also for the treatment of mal-positioned teeth.

In another embodiment as shown in 4E, the plurality of cleaning elements can have their free ends cut so that the free ends form an essentially oval depression 290 in the cleaning element field with two opposite flat portions 291, 292 of the cleaning element field that are parallel to the mounting surface 202. The two flat portions 291 and 292 may each in particular be arranged to centrically lie on the longitudinal extension axis of the cleaning section such that in case the cleaning section is placed in the oral cavity the oval depression 290 can accommodate a typical tooth such as a molar and the flat portions may then enter into the interproximal areas. The maximum width (w) of the flat portions 291 and 292 measured along the direction of an axis connecting the centers of the opposite flat portions may be chosen to lie in a range of between about 0.75 mm and 2.0 mm, in another embodiment between about 1.0 mm and about 1.5 mm.

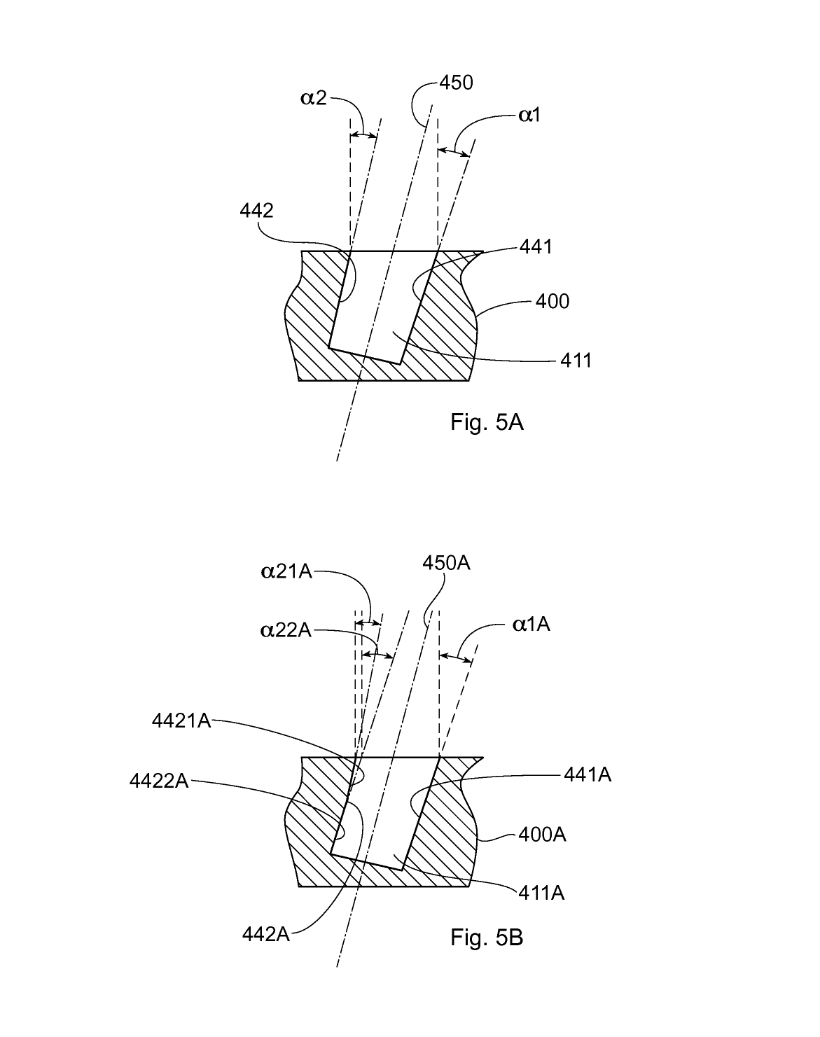

FIG. 5A is a schematic cross sectional cut through a first carrier with a first example embodiment of a mounting hole 411 present in a carrier 400 that can be utilized for anchor tufting of a cleaning element, for example, a bristle tuft. The cross sectional cut of the mounting hole 411 may be taken in circumferential direction through a tuft hole as shown in FIG. 4C. The dashed-dotted line 450 indicates the central line of the cleaning element to be mounted into the mounting hole 411. The dashed-dotted line 450 coincides with the circumferential inclination of the cleaning element to be mounted. The “inner” circumferential wall 441 of the tuft hole 411, i.e. the wall against which the cleaning element will rest in its mounted state, is inclined against a normal on the mounting surface with an inclination angle of α1. The opposite wall 442 is inclined against a normal on the mounting surface with an inclination angle of α2, where α1>α2. Thus, the tufting hole 411 has an essentially trapezoidal cross section in this vertical cross-sectional cut. The absolute value of the difference in the inclination angles α2 and α1 may be chosen to lie in a range of between about 0.1 degrees to about 3 degrees.

FIG. 5B is a schematic cross sectional cut through a carrier 400A with a second example embodiment of a mounting hole 411A present in the carrier that can be utilized for anchor tufting of a cleaning element, for example, a bristle tuft. In this second example embodiment, the outer wall 442A of the tufting hole 411A has a lower wall section 4422A that is inclined with an angle α22A that is similar or identical to the inclination angle α1A of the inner wall 441A. The outer wall 442A has a second upper wall section 4421A that is inclined with an angle α21A that is smaller than the inclination angle α1A of the inner wall 441A. The absolute value of the difference in the inclination angles α21A and α1A may be chosen to lie in a range of between about 0.1 degrees to about 3 degrees.

Alternately or additionally, the other walls of a tufting hole, i.e. the walls defining the tufting hole essentially in radial direction, may likewise be differently inclined, where the inclination angle of each radial wall may be chosen to lie in a range of between about 0 degrees to about ±3 degrees. The mounting surface and thus the diameter of the carrier may be chosen to lie in a range of between about 7 mm to about 18 mm, in another embodiment between about 8 mm to about 15 mm. The carrier may be oval or ellipsoidal instead of circular, were the longer axis may be chosen to lie in a range of between about 11 mm to about 18 mm and the small axis may be chosen to lie in a range of between about 7 mm to about 12 mm.

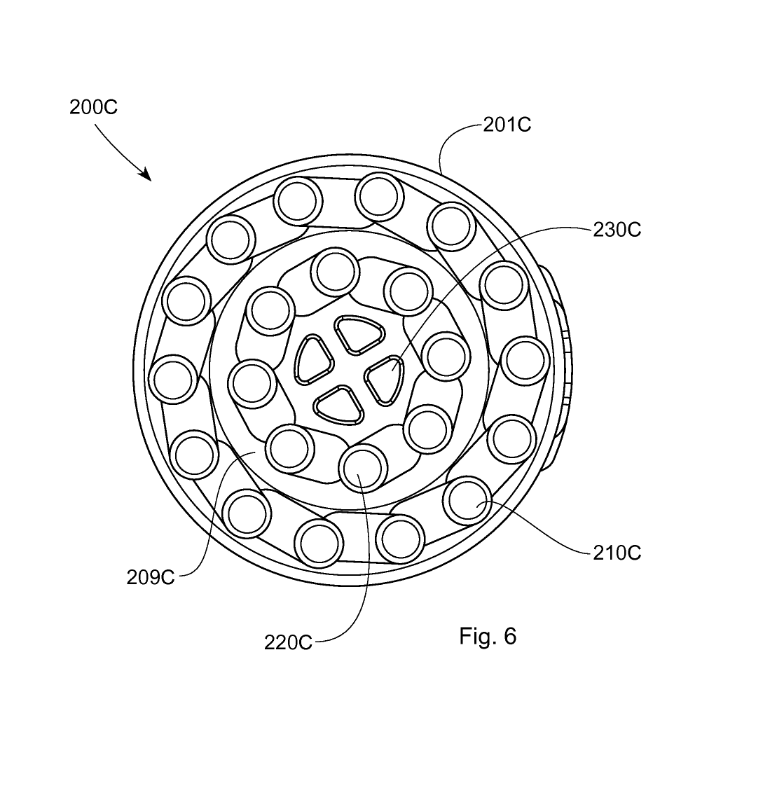

FIG. 6 is a top view onto a cleaning head 200C of a further example embodiment. Here, the plurality of cleaning elements 210C of the outer band are arranged on a first carrier 201C. The plurality of cleaning elements of the outer band 210C may be inclined in a circumferential direction (here: in anti-clockwise direction). The plurality of cleaning elements 220C of the inner band can be arranged on a second carrier 209C. The second carrier 209C is coaxially arranged with the first carrier 201C. The second carrier may be arranged to be static, i.e. the second carrier will not be driven during operation, or the second carrier may be arranged to be driven counter direction or with opposed phased relative to the first carrier during operation. Further inner zone cleaning elements 230C are mounted on the second carrier 209C.

### Test Methods

The test methods and apparatus described below may be useful in testing embodiments of the present disclosure:

### COLOR CONTRAST (ΔE*)

The Color Contrast (ΔE*) is determined as follows:

### Equipment

Scalpel
Tweezers
Cleaning element holder/support
Soldering gun
Konica Minolta CM-2600d Spectrophotometer. The spectrophotometer is available from Konica Minolta Sensing Americas, Inc, New Jersey
Computer

### Definitions

Color Contrast (ΔE*)=(ΔL*²+Δa*²+Δb*²)^{1/2}

### Test Procedure

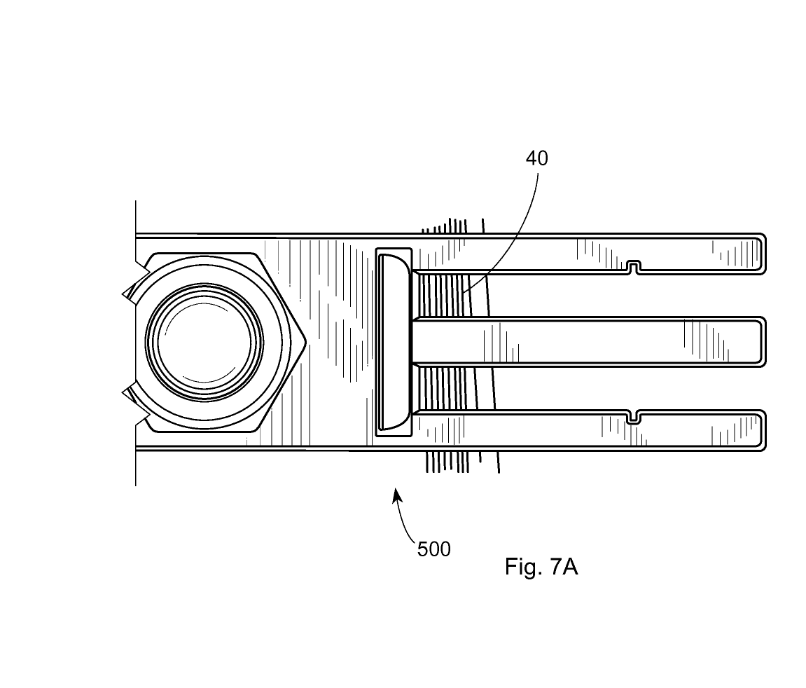

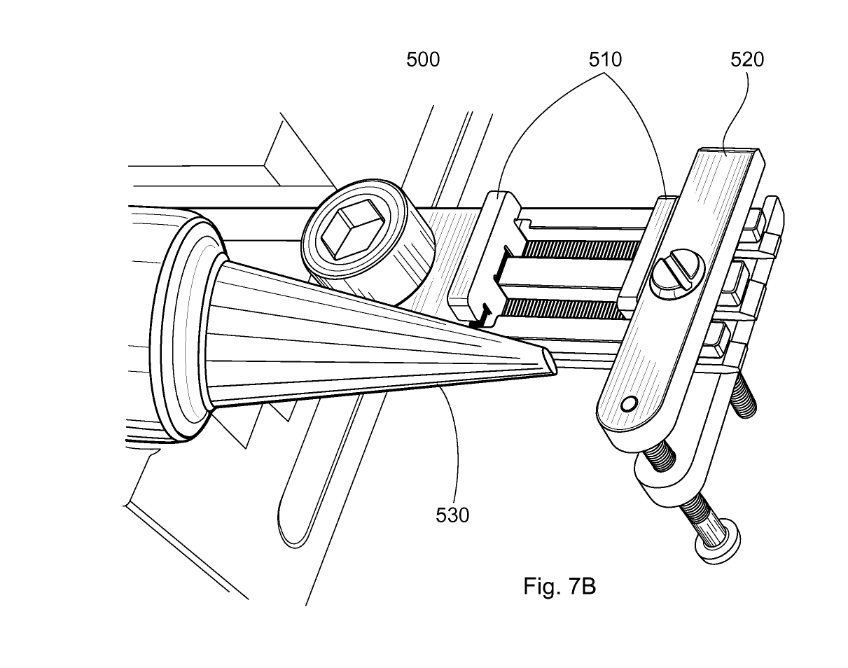

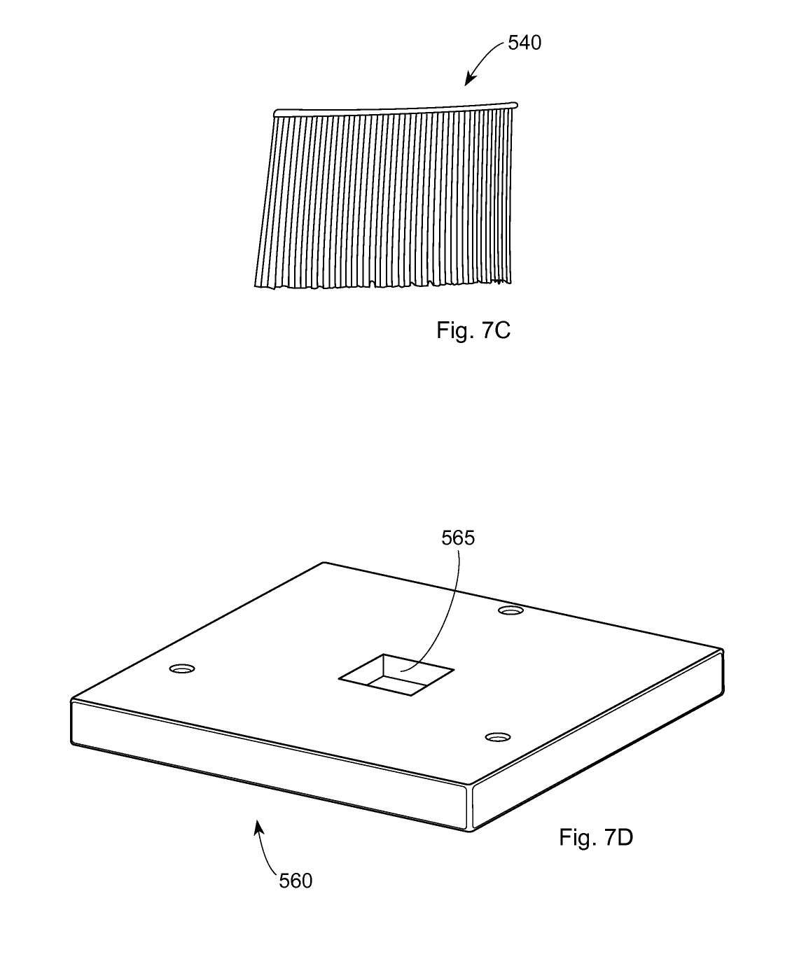

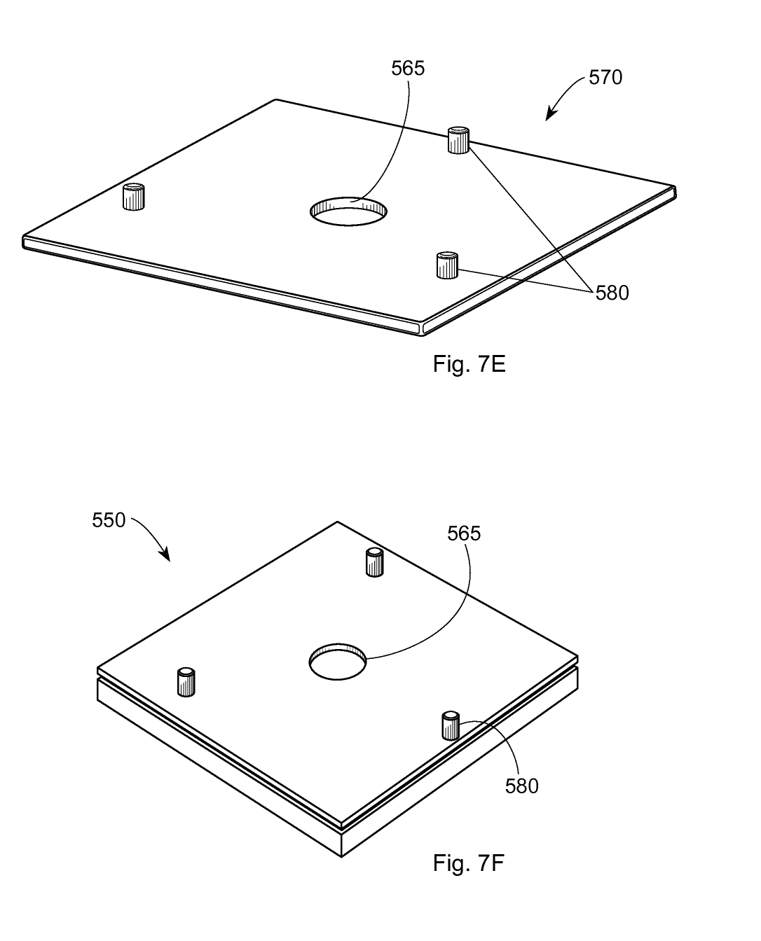

Obtain a test specimen, for example, a cleaning section for an oral hygiene device having a plurality of cleaning elements 40 mounted on a carrier.
Remove the cleaning elements having a first color from the carrier using a scalpel and a pair of tweezers.
Cut the cleaning elements using the scalpel to a height of approximately 7.0 mm
Using the tweezers, place the individual cleaning elements 40 on a cleaning element holder/support 500 in a side-by-side configuration as shown in FIG. 7a. As shown in FIG. 7a, the cleaning element holder/support 500 in this example is a fork-like platform. The cleaning elements 40 are individually placed on the cleaning element holder/support 500 in order to create a film or layer 540 that is approximately 7.0 mm×7.0 mm. The cleaning element film 540 has a thickness or caliper of approximately 0.15 mm to 0.18 mm.
Make sure the approximately 7.0 mm×7.0 mm cleaning element film 540 is fixed in place on the cleaning element holder/support. As shown in FIG. 7b, the film is secured using a parallel screw clamp 520 and a pair of backstoppers 510.
Weld the top and bottom edges of the cleaning element film 540 using a soldering gun 530. See FIG. 7b. Remove the film 540 from the cleaning element holder/support 500. The film 540 is illustrated in FIG. 7c.
A total of 7 cleaning element films are created for the cleaning elements 40 having a first color.
The 7 cleaning element films are stacked on top of each other in a film holder 550. The film holder 550 has a base section 560 and a lid 570 as illustrated in FIGS. 7d and 7e. The film holder 550 is approximately 40 mm×40 mm and a central region 565 of the base section 560 is configured for holding the films 540. The central region 565 of the base section 560 is approximately 7.1 mm×7.1 mm×1.5 mm. The film holder 550 is constructed of a black plastic material in order to reduce light scattering. As illustrated in FIG. 7e, the lid 570 has 3 small cylindrical rods 580 to assist in holding the diaphragm of the spectrophotometer is place during measurement. A film holder 550 loaded with films 540 is illustrated in FIG. 7f. Film holder 550 has a thickness of approximately 4.5 mm
The L*a*b* values of the test specimen is measured using the spectrophotometer.
The measurement and calculation for the L*a*b* values is based on the following conditions: observer 10°, CIE Standard Illuminant D65 light conditions, room temperature of 20-23° C. The spectrophotometer has a diaphragm for measuring area Ø=3 mm @ SAV. The illumination area has a cross section diameter Ø of 6.0 mm and the lid of the film holder has a cross section diameter Ø of 6.5 mm
The measurement is repeated 3 times for each test specimen and the L*a*b* values are aggregated to calculate an average and standard deviation. The L*a*b* values are calculated and recorded by a computer that is connected to the spectrophotometer.
The above test procedure can be repeated for each different color cleaning element that is present on the carrier. Once the L*a*b* values are calculated for each different color cleaning element, the Color Contrast can be obtained by the formula: ΔE*=(ΔL*²+Δa*²+Δb*²)^{1/2}.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning section for an electric oral hygiene device having a handle section, the cleaning section comprising:
a) a first end adapted to be connected to the handle section;
b) a second end remote from the first end, the second end including a carrier mounted for rotation or oscillation around a rotation axis; and
c) a plurality of cleaning elements mounted on the carrier, the cleaning elements being arranged in at least an inner band and an outer band;
wherein the inner band includes a plurality of first cleaning elements having a first color and a plurality of second cleaning elements having a second color; wherein the outer band includes a plurality of third cleaning elements having a third color and a plurality of fourth cleaning elements having a fourth color; and wherein the cleaning elements of the inner band and the cleaning elements of the outer band have a Color Contrast (ΔE*) of from about 85 to about 140.

2. The cleaning section according to claim 1, wherein the plurality of first and second cleaning elements is inclined in a circumferential direction such that a free end of each of the first and second cleaning elements is farther away in the circumferential direction than a base of the respective cleaning element.

3. The cleaning section according to claim 2, wherein the plurality of first cleaning elements exhibit a circumferential inclination angle of from about 0 degrees to about 35 degrees.

4. The cleaning section according to claim 1, wherein the plurality of first cleaning elements exhibit a first color having a L*a*b* value of from about 72, −7, 60 to about 91, 9, 114; and a plurality of second cleaning elements exhibit a second color having a L*a*b* value of from about 64, 26, 57 to about 88, 60, 88.

5. The cleaning section according to claim 1, wherein the plurality of third cleaning elements exhibit a third color having a L*a*b* value of from about 49, −30, −46 to about 80, −5, −14; and a plurality of fourth cleaning elements exhibit a fourth color having a L*a*b* value of from about 15, −4, −78 to about 46, 38, −30.

6. A cleaning section for an electric oral hygiene device having a handle section, the cleaning section comprising:
a) a first end adapted to be connected to the handle section;
b) a second end remote from the first end, the second end including a carrier mounted for rotation or oscillation around a rotation axis; and
c) a plurality of cleaning elements mounted on the carrier, the cleaning elements being arranged in at least an inner band and an outer band;
wherein the inner band includes a plurality of first cleaning elements having a first color and a plurality of second cleaning elements having a second color; wherein the outer band includes a plurality of third cleaning elements having a third color and a plurality of fourth cleaning elements having a fourth color, the cleaning elements within the outer band having a Color Contrast (ΔE*) of less than about 50% of the Color Contrast (ΔE*) of the cleaning elements within the inner band.

7. The cleaning section according to claim 6, wherein the plurality of first and second cleaning elements is inclined in a circumferential direction such that a free end of each of the first and second cleaning elements is farther away in the circumferential direction than a base of the respective cleaning element.

8. The cleaning section according to claim 6, wherein the plurality of third and fourth cleaning elements is inclined in a circumferential direction such that a free end of each of the third and fourth cleaning elements is farther away in the circumferential direction than a base of the respective cleaning element.

9. The cleaning section according to claim 7, wherein the plurality of first cleaning elements and the plurality of second cleaning elements exhibit a circumferential inclination angle of from about 0 degrees to about 35 degrees.

10. The cleaning section according to claim 8, wherein the plurality of third cleaning elements and the plurality of fourth cleaning elements exhibit a circumferential inclination angle of from about 0 degrees to about 35 degrees.

11. The cleaning section according to claim 6, wherein the plurality of first cleaning elements exhibit a first color having a L*a*b* value of from about 15, −4, −78 to about 46, 38, −30 and a plurality of second cleaning elements exhibit a second color having a L*a*b* value of from about 60, −76, 37 to about 70, −36, 72.

12. The cleaning section according to claim 6, wherein the plurality of third cleaning elements exhibit a third color having a L*a*b* value of from about 49, −30, −46 to about 80, −5, −14; and a plurality of fourth cleaning elements exhibit a fourth color having a L*a*b* value of from about 88, −5, −5 to about 100, 5, 5.

13. A cleaning section for an electric oral hygiene device having a handle section, the cleaning section comprising:
a) a first end adapted to be connected to the handle section;
b) a second end remote from the first end, the second end including a carrier mounted for rotation or oscillation around a rotation axis; and
c) a plurality of cleaning elements mounted on the carrier, the cleaning elements being arranged in at least an inner band and an outer band;
wherein the inner band includes a plurality of cleaning elements having a first color; wherein the outer band includes a plurality of cleaning elements having a second color and a plurality of cleaning elements having a third color; and
wherein the cleaning elements of the inner band and the cleaning elements of the outer band have a Color Contrast (ΔE*) of from about 85 to about 140.

14. The cleaning section according to claim 13, wherein the plurality of first and second cleaning elements is inclined in a circumferential direction such that a free end of the first and second cleaning elements is farther away in the circumferential direction than a base of the respective cleaning element.

15. The cleaning section according to claim 13, wherein the plurality of third and fourth cleaning elements is inclined in a circumferential direction such that a free end of the third and fourth cleaning elements is farther away in the circumferential direction than a base of the respective cleaning element.

16. The cleaning section according to claim 14, wherein the plurality of first cleaning elements and the plurality of second cleaning elements exhibit a circumferential inclination angle of from about 0 degrees to about 35 degrees.

17. The cleaning section according to claim 13, wherein the plurality of first cleaning elements exhibit a first color having a L*a*b* value of from about 64, 26, 57 to about 88, 60, 88.

18. The cleaning section according to claim 13, wherein the plurality of cleaning elements of the outer band exhibit a second color having a L*a*b* value of from about 49, −30, −46 to about 80, −5, −14 and a third color having a L*a*b* value of from about 95, −5, −5 to about 100, 5, 5.

19. A cleaning section for an electric oral hygiene device having a handle section, the cleaning section comprising:
a) a first end adapted to be connected to the handle section;
b) a second end remote from the first end, the second end including a carrier mounted for rotation or oscillation around a rotation axis; and
c) a plurality of cleaning elements mounted on the carrier, the cleaning elements being arranged in at least an inner band and an outer band;
wherein the inner band includes a plurality of first cleaning elements having a first color and a plurality of second cleaning elements having a second color, the cleaning elements within the inner band having a Color Contrast (ΔE*) of greater than about 95; wherein the outer band includes a plurality of third cleaning elements having a third color and a plurality of fourth cleaning elements having a fourth color, the cleaning elements within the outer band having a Color Contrast (ΔE*) of less than about 60.

20. A cleaning section for an electric oral hygiene device having a handle section, the cleaning section comprising:
a) a first end adapted to be connected to the handle section;
b) a second end remote from the first end, the second end including a carrier mounted for rotation or oscillation around a rotation axis; and
c) a plurality of cleaning elements mounted on the carrier, the cleaning elements being arranged in at least an inner band and an outer band;
wherein the inner band includes a plurality of cleaning elements having a cross-section in a substantially parallelogram shape; and wherein the outer band includes a plurality of cleaning elements having a cross-section in a substantially rectangular shape and a plurality of cleaning elements having a cross-section in a substantially trapezoidal shape, such that the cross-sections in the outer band alternate.
